(19) United States
(12) Patent Application Publication
(10) Pub. No.: US 2004/0210560 A1
(43) Pub. Date: Oct. 21, 2004

(54) Method and system for searching a wide area network

(76) Inventor: Gary Stephen Shuster, Fresno, CA (US)

Correspondence Address: O'MELVENY & MYERS LLP, 400 So. Hope Street, Los Angeles, CA, 90071-2899, US

(21) Appl. No.: 10/414,634

(22) Filed: Apr. 16, 2003

(51) Int. Cl. G06F 17/30

(52) U.S. Cl. 707/3

(57) ABSTRACT

According to a system and method of the invention, a user computer has a browser and is connected to the wide area network. A Web host is also connected to the wide area network and includes a web server. The web server runs a search interface application. Information that has been previously selected from the wide area network by users of the system is stored in a memory, and the memory is connected to the Web host. A user of the system selects a set of the information, which is stored in the memory, that the user wishes to search. The user enters a search query into the search interface, and the search interface searches only the selected information based on the search query. The search interface obtains hyperlinks to pages that contain the desired information.

### CROSS-REFERENCE TO RELATED APPLICATION

This application claims the benefit of U.S. Provisional Application No. 60/373,005, filed Apr. 15, 2002, which application is specifically incorporated herein, in its entirety, by reference.

### BACKGROUND OF THE INVENTION

1. Field of the Invention

The present invention relates to a method and system for performing a user-specified search of information on a wide area network, such as the Internet.

2. Description of Related Art

The amount and variety of information accessible on the Internet, and in particular, through the World Wide Web, is now extremely vast and continues to grow very rapidly. At the same time, as the Internet grows in popularity, quickly locating useful and accurate information on the Internet is becoming both more important and more difficult.

Various methods, such as employed by search engines, have been developed to help Internet users locate information. Search engines are typically accessible through Web sites. Some Web sites provide access to multiple search engines, or to combinations of search engines and directories. Search engines deliver their information in a similar format i.e., as a list of URL's for selected websites (commonly called “hits”), organized by category and/or by search query. Typically, each hit is presented as a hyperlink on a HyperText Mark-up Language (HTML) results page produced by the search engine. Such results pages may list other information about each hit, such as the Web site Meta Tags, and rank the hits using a variety of ranking algorithms.

Search engines are capable of locating information from a large set of Web pages, but frequently at the cost of making it more difficult to locate the most relevant information. A typical search engine utilizes a database containing an enormous, frequently updated index of Web pages. The database is maintained and updated using an automated or semi-automated process relying on a variety of indexing, searching, and ranking algorithms. The operation of various search algorithms are known, and it is not uncommon for Web page authors to deliberately design pages in a manner that boosts the likelihood of being selected by a search engine as highly relevant to a particular search topic, when the actual information content of the page pertaining to the search topic is poor or even completely irrelevant. Also, many Web pages that are not deliberately designed to be selected by a searching algorithm are nonetheless selected inappropriately for other reasons. For example, a search for a word having multiple meanings will retrieve results for all of the meanings, although results for only a single meaning are usually desired. Perhaps even more frequently, pages with many of the query search terms nonetheless have little useful information. Thus, because of the enormous size of the search engines' databases, and the limitations of the algorithms employed by them, search engines often provide a large quantity of useless or irrelevant information. It is often very time-consuming for a user to evaluate and discard the many useless results that are returned.

After performing the time-consuming searches, a user may discover a Web page that is pertinent to the search topic but the user may forget to save the URL for the discovered Web page. The user may also discover other Web pages that are not pertinent to the search topic but that are pertinent to a new search topic that a user wishes to search at a later time. When the user attempts to perform a search for Web pages pertaining to the new topic, the search engine will search the entire index of Web pages and may not identify the Web pages that were previously discovered by the user.

In addition, third party users of a Local Area Network (LAN) or of a particular search site may also have searched for and retrieved Web pages pertinent to the user's new search topic. According to known search engines, the user cannot take advantage of the pages discovered by other third party users when the user is searching for Web pages pertinent to the new search topic. As a result, when the user performs a new search, the search engine takes a large amount of time and expends a great amount of processing power to search the entire universe of indexed Web pages. Further, by searching the entire universe of Web pages, the Web pages already discovered by the user and/or other third party users may not be identified.

Thus, there exists a need for a method and system for searching a wide area network that permits users to search a set of information that has already been selected from the wide area network.

### SUMMARY OF THE INVENTION

The present invention provides a method and system for searching a wide area network that enables users to search a set of information that has already been selected from the wide area network. According to a system and method of the invention, a user computer has a browser and is connected to the wide area network. A Web host is also connected to the wide area network and includes a web server. The web server runs a search interface application. Information that has been previously selected from the wide area network by users of the system is stored in a memory, and the memory is connected to the Web host.

A user of the system selects a set of the information, which is stored in the memory, that the user wishes to search. The user can select information that has been previously selected by predetermined users who the user believes have discovered desired information. The user enters a search query into the search interface while attempting to locate the desired information. The search interface searches only the selected information based on the search query and obtains hyperlinks to pages that contain the desired information.

In another embodiment, the user selects information that has been previously selected by the user, other users, or both the user and other users. The memory further comprises a set of prior query strings that were previously defined by other users of the system. And, the search interface identifies the other users by identifying an important term within the user's search query and searching the prior query strings for the important term. The search interface identifies those users who previously defined query strings that include important terms within the user's search query.

Thus, pursuant to methods and systems of the invention, only information previously selected by predetermined users that might include the desired information is searched. In the alternative or in addition, other information may also be searched. This reduces the amount of information that must be searched and also increases the likelihood of discovering pages that include desired information that predetermined users have previously discovered.

A more complete understanding of the method and system for a search engine for use on a wide area network will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a block diagram illustrating a system for searching a wide area network according to the present invention;

FIG. 2 is a block diagram illustrating an alternative system for searching a wide area network according to the present inventin;

FIG. 3A is a diagram illustrating visual elements of an exemplary search definition page according to the invention;

FIG. 3B is a diagram illustrating visual elements of an exemplary search result page according to the invention; and,

FIG. 4 is a flow chart showing an overview of the steps for performing the method of searching a wide area network.

### DETAILED DESCRIPTION OF THE PREFERRED EMBODIMENT

The present invention provides a method and system for searching a wide area network that enables users to search a set of information that has already been selected from the wide area network by other users. Thus, pursuant to methods and systems of the invention, by searching a more limited set of information, a user may find desired information that either the user, other users, or both the user and other users have selected from the wide area network faster than methods of the prior art, which requires users to search a vast universe of information. In the detailed description that follows, like element numerals are used to describe like elements illustrated in one or more figures.

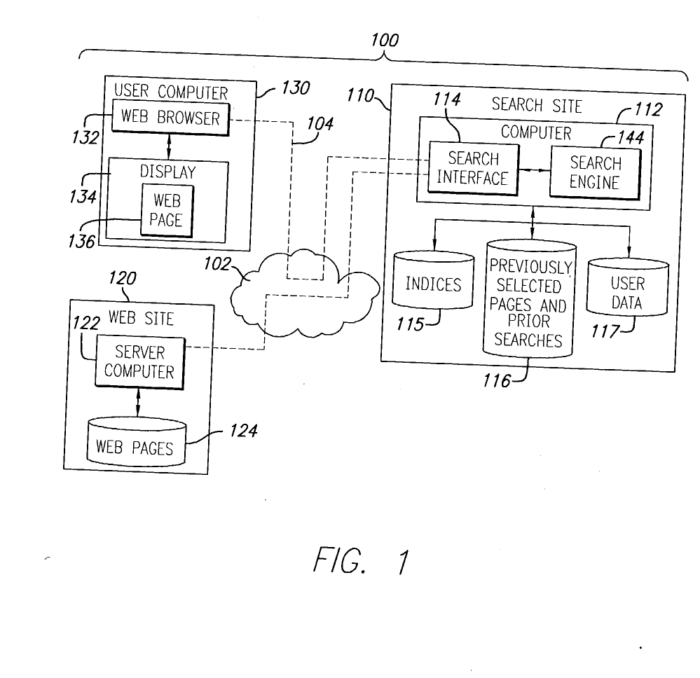

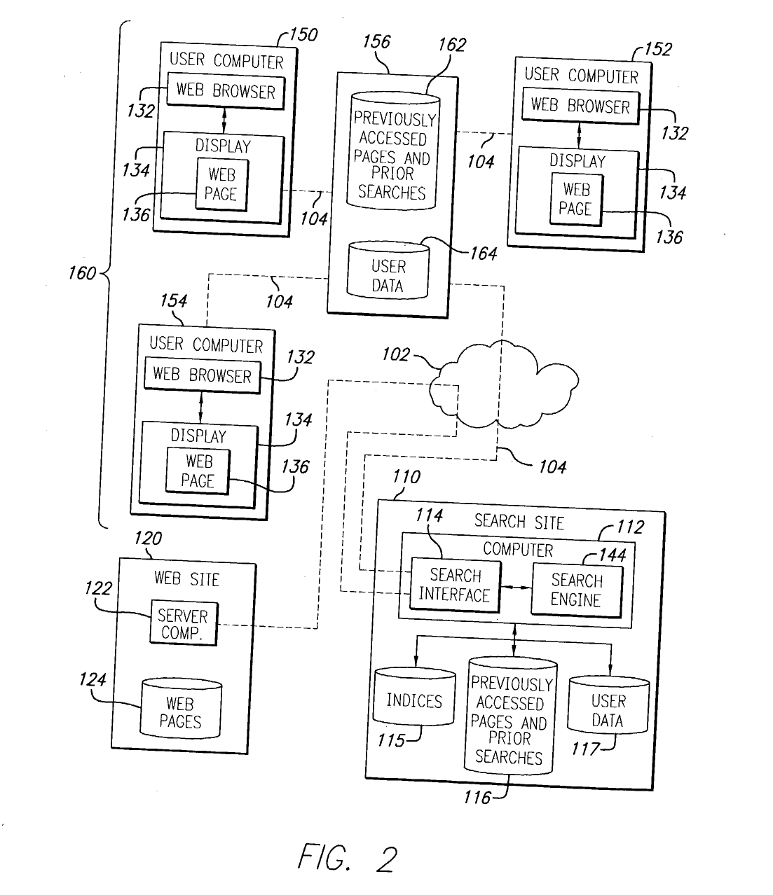

Referring to FIG. 1, a block diagram is illustrated of a wide area network employing a search method and system according to the invention. It is anticipated that the present information delivery system 100 operates with a plurality of computers which are coupled together on a wide area network, such as the Internet 102, or other communications network. FIG. 1 depicts a network that includes a user computer 130 that communicates with a search site 110 though communication links 104 that include the Internet 102. The network further includes a Web site 120, which communicates with a user computer 130 and with the primary search site 110. The user computer 130 may be any type of computing device that allows a user to interactively browse web sites, such as a personal computer (PC) that includes a Web browser 132 (e.g., Microsoft Internet Explorer™ or Netscape Communicator™). Suitable user computers 130 equipped with browsers 132 are available in many configurations, including handheld devices (e.g., PalmPilot™), personal computers (PC), laptop computers, workstations, television set-top devices, multi-functional cellular phones, and so forth. As shown in FIG. 2, in an alternative embodiment, there may be a Local Area Network (LAN) 160 that is in communication with the search site 110 via a communication link 104 and a server computer 156. The LAN 160 comprises a plurality of user computers 150, 152, 154 that are in communication with one another via communication links 104 and the server computer 156.

In both the embodiments shown in FIGS. 1 and 2, the search site 110 includes a search server computer 112 running search interface application 114 and capable of selectively delivering data files, such as HTML files, to the user computer 130, 150, 152, 154 using a protocol, such as HTTP. Search interface 114 is in communication with a search engine 144.

Search interface 114 is also in communication with various databases, such as Internet index 115, previously selected pages and prior search queries database 116, and user data database 117 while performing functions according to the present invention. As shown in FIG. 1, in one embodiment, the previously selected and prior search database 116 and the user data database 117 include information pertaining to all users who have selected the search site. In another embodiment (not shown), in the alternative or in addition, other databases that include previously selected information, prior searches, and user data pertaining only to the user may reside at the user computer 130. As shown in the embodiment of FIG. 2, in the alternative or in addition, another previously selected and prior search query database 162 and the user data database 164 may also reside at the server computer 156 and include information pertaining to users 150, 152, 154 within the LAN 160. Note that the previously selected and prior search database 116, 162 may include web pages or URL addresses to Web pages that contain previously selected information, or a combination of both. The previously selected and prior search database 116, 162 may also include other data that either directs the search engine 144 to information previously selected by users or to the previously selected information itself.

Typically, as shown in FIGS. 1 and 2, search interface 114 and search engine 144 include an application coded in various programming languages, such as C or C++, and are customized to run on a server 112. Search engines, such as 144, typically incorporate a database engine, such as a SQL Server™ engine from Microsoft Corporation or Oracle™ database engine, as part of their architecture. Search engines typically perform searches by operating on a string of characters, known as a “query string.” A query string is coded according to a set of rules determined by the database engine and/or a user interface between the database engine and the user. As used herein, a “query” is broader than a “query string,” denoting both the query string and the search logic represented by the query string, whereas “query string” refers only to a string of characters, symbols, or codes used to define a query.

Web site 120 includes Web server 122 and accesses a database of Web pages 124, distributable applications, and other electronic files containing information of various types. Web pages 124 may be viewed on display 134 of user computer 130; for example, Web page 136, other electronic files may be viewed on display 134 by a suitable application program residing on user computer 130, such as browser 132, or by a distributable application provided to user computer 130 by Web server 122. It should be appreciated that many different user computers, many different Web servers, and many different search servers of various types may be communicating with each other at the same time.

The present invention allows a user to locate Web pages and other files containing desired information pertaining to any particular query, referred to as “relevant pages.” Relevant pages are located on one or more Web sites, which may be connected together through links including the Internet 102. Furthermore, the invention assists the user in locating the most relevant pages from a multiplicity of previously selected pages.

Web pages are generally requested by communicating an HTTP request from the browser application 132. The HTTP request includes the Uniform Resource Locator (URL) of the desired Web page, which may correspond to a Web page 124 stored at a destination Web site, such as search site 110. The HTTP request is routed to the Web server 122 via the Internet 102. The Web server 122 then retrieves the requested Web page, identified by a URL, from database 124 and communicates the Web page across the Internet 102 to the browser application 132. The Web page may be communicated in the form of plural message packets as defined by standard protocols, such as the Transport Control Protocol/Internet Protocol (TCP/IP), although it should be appreciated that communication using other protocols would be within the scope of the invention.

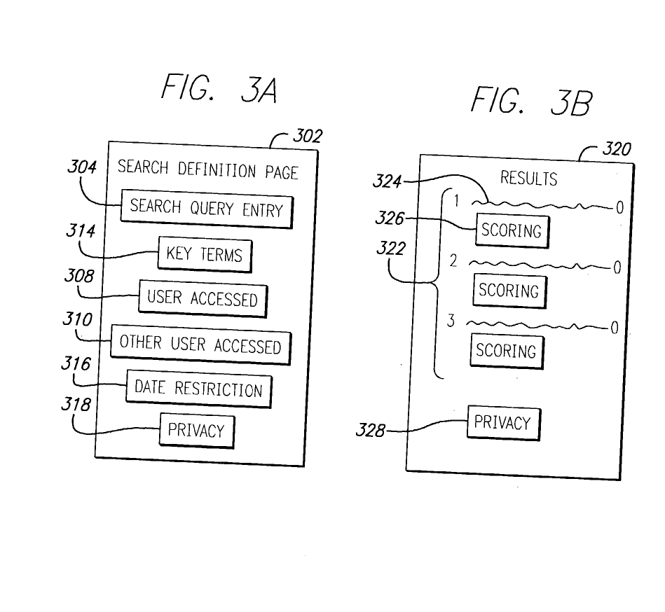

Schematic diagrams exemplary of the visual organization of various Web pages viewed during a performance of one embodiment of the invention are provided in FIGS. 3A and 3B. Referring now to FIG. 3A, a search for relevant pages is initiated when a user connects with search site 110 using user computer 130, and requests a search definition page, for example, page 302, from search server computer 112. Search definition page 302 comprises a Web page that preferably includes a search query entry field 304, and buttons 308, 310 to limit the information searched to a set of information previously selected by the user (308) or other users (310). If the user is within a LAN 160, there may be another button (not shown) to limit the information searched to users of the LAN 160. There may also be a key term field 314, date restriction button 316 and a privacy button 318. The key term field 314 allows the user to enter key terms of the search query that are relevant to the desired information, the date restriction button 316 permits the user to limit the information searched to information selected within a selected date range, and the privacy button 318 allows the user to prevent the search interface 114 from storing queries entered by the user.

After entering and refining one or more search queries using search entry page 302, the user sends the query or queries to search server 112. Using its search interface 114 and search engine 144, search server 112 performs a search and operates on the search results according to the method and processes described below. Search interface application 114 is comprised of a program, or a plurality of cooperating programs, which perform functions according to the present invention. In performing the search and subsequent operations, search site 110 preferably communicates with one or more Web sites, such as Web site 120.

Referring now to FIG. 3B, the operations performed by primary search server 112 include generating one or more Web pages 320 that contain various summaries of the search results, referred to as “results pages.” Results pages 320 preferably include hyperlinks 322 to the relevant pages identified by the search interface 114. Results pages 320 may also further include interactive fields for collecting user data, such as scoring field 326. Interactive fields may be created using HTML, or a distributable application programming language such as JAVA. A user interacts with an interactive field by pointing, clicking, dragging, and performing similar operations with a mouse or similar pointing device, or by using a computer keyboard, or by using any other device that provides for input into a computer which is linked to the interactive field.

Hyperlinks 322 include links 324 directly to the relevant pages located at one or more Web sites anywhere on the Internet, and/or links 328 to copies of the relevant pages that have been cached on a network server, preferably the search server 112, or on user computer 130, during post-search operations by search interface 114.

Search server 112 sends results pages 320 to user computer 130, allowing the results pages to be viewed by a user on display 134. Preferably, results pages 320 include interactive fields for collecting the user's opinion of the usefulness and relevance of the search results, such as scoring field 326. The scoring field 326 permits the user to rank a corresponding hyperlink 322 based on the relevancy of the hyperlink 322 to the important terms. User opinions, such as the scores or ranks of the corresponding hyperlinks 322, are collected with the active participation of the user and, hence, are referred to as “active data.” Additionally, search server optionally sends commands that are embedded in files such as cookies or Web pages and encoded in languages such as HTML and Java. The commands are sent to the user computer 130, which collects information about the user's interaction with the results pages and relevant results. Such information is preferably collected without active participation by the user and, hence, is referred to as “passive data.” Passive data is preferably collected with the user's consent, which may be obtained at any time before, after, or during a search process. The consent may obtained by a privacy button 328 that, when activated, stops the collection of active and passive user data. Active data and passive data are transmitted to the primary search server 112 and collected in one or more databases for future use, thereby concluding a search cycle. The cycle is repeated at the option of the user by initiating another search as described above.

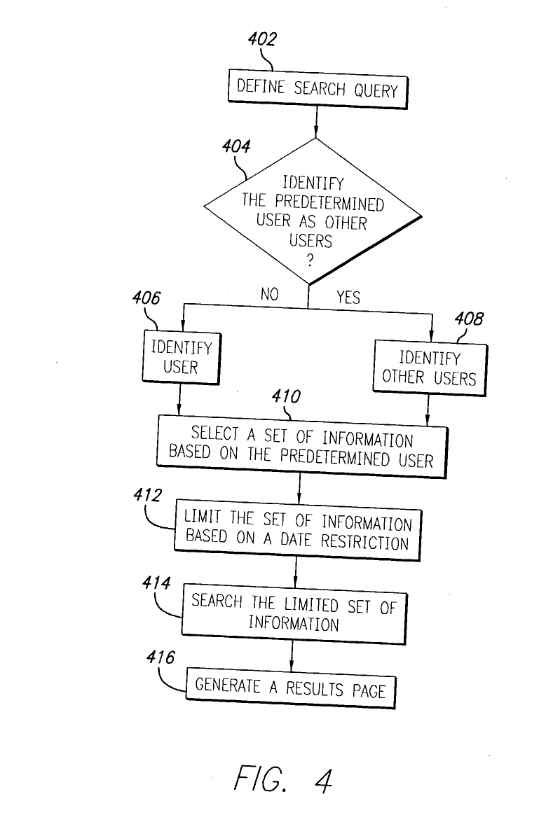

Referring now to FIG. 4, a flow chart illustrates exemplary operation of the search interface 114 in accordance with the foregoing description of the invention. A search is initiated and result Web pages are generated per a search method 400. Pursuant to an embodiment of the invention, a user searches a set of information to be searched that has been previously selected by predetermined users. The user selects the set of information by identifying a predetermined user that the user believes may have selected relevant pages containing desired information. The user then formulates a search query to locate the desired information. Additional details about the method illustrated in FIG. 4 are provided in the description below.

At step 402, the user defines a query to locate desired information. In one embodiment, the user enters the query into the search query entry field 304. In other embodiments, there is a key term field 314 for the user to enter a key term(s) of the search query that is relevant to the desired information. For example, if the user desired information pertaining to “current issues in astrophysics,” the key term would be “astrophysics,” and the user would enter “astrophysics” in the key term field 314. The user's query is then stored by the server 112 into the previously selected information and prior searches database 116, 162. In an alternate embodiment, the user may activate a privacy button 318 to prevent the server 112 from storing the query.

At steps 404 to 410, the user selects a set of previously selected information to be searched based on a predetermined user. Specifically, at step 404, the user identifies a predetermined user that the user believes may have selected relevant web pages that contain desired information. In one embodiment, if the user believes that he has previously selected relevant pages that contain the desired information, at step 406, the user identifies the predetermined user as the user himself by pressing button 308. As a result, the set of information to be searched is limited to information previously selected by the user. If the user believes that other users may have selected relevant pages that contain the desired information, at step 408, the user presses button 310 to identify the predetermined user as other users. As a result, the information to be searched is limited to information previously selected by other users. Depending on who the user believes may have previously selected the desired information, the user may identify both the other users and the user himself by pressing both buttons 308 and 310 to limit the set of information to be searched to information that has been selected by both the user and other users.

In the embodiment shown in FIG. 4, at step 406, a user identifier (“ID”) is passed to the search server. The user identifier may be obtained from a cookie placed on the user computer during a prior search, or by a login process requesting a user ID, such as a user name or password. The server determines whether the user ID is recognized by comparing it to a database of prior user ID's. If the user ID is not recognized, a user ID is preferably established. A user ID can be established by various processes, including, for example, a user registration process or by sending a cookie to the user computer. After a user ID is established, the set of information to be searched is limited to the user's previously selected information at step 410. Those of skill in the art will understand that there are other known methods to identify a user, and those known methods may also be used in this invention to identify the user and to identify information that the user previously selected.

In the embodiment shown in FIG. 4, at step 408, the other users that the user believed may have selected relevant pages containing the desired information are identified. In one embodiment, the server 112 removes undesired terms of the search query that the user entered in the search query field 304 and compares the remaining pertinent terms of the search query to prior search queries of other users that are stored in database 116. Undesired terms are stored in an undesired term database (not shown), and the server 112 can compare terms in the undesired term database to the search query. The server 112 can then remove any matches. For example, the undesired terms database may include operators such as “or” and “and,” and common words such as “the,” “a,” and “in.” If the search query entered were “current issues in astrophysics,” the term “in” would be removed and the query “current issues astrophysics” would be compared to prior searches stored in database 116. Those of skill in the art will appreciate that there are other known methods for removing undesired terms from a query and that any of the known methods may be used to remove undesired terms of the search query entered by the user. In another embodiment that includes the key term field 314, the server compares the key terms to the prior search queries of other users that are stored in database 116. Note that, as used in this application, the phrase “important terms” includes both “pertinent terms” and “key terms,” as “pertinent terms” and “key terms” have been provided above.

In the embodiment shown in FIG. 4, at step 408, after comparing the user's search query to prior search queries of other users, the server 112 identifies the other users whose prior search queries are matched closest to the user's search query. Those of skill in the art will appreciate that there are several known methods and several variations thereof that may be used to compare search queries to one another to identify a closest match. All such known methods and variations may be used to compare the user's search query to the prior search queries of other users in order to determine a closest match and identify the other users. The other users who performed the search queries having the closest match are identified and, at step 308, the set of information to be searched is limited to information the identified other users have previously selected.

Preferably, as shown in FIG. 4, at step 412, a user may further limit the set of information to be searched by entering a date restriction in date restriction field 216. The computer server 112 removes information that has been selected in a date that falls outside of the date restriction from the set of identified information to be searched.

As shown in FIG. 4, at step 414, the set of information to be searched determined at step 410, and, if applicable, step 412, is searched per the search query defined by the user per known searching methods. In the alternative or in addition, other information may also be searched. At step 416, the results are provided in a results page 320, shown in FIG. 3B. The results page 320 includes a plurality of hyperlinks 324 to relevant pages that include the desired information. The pages that the user selects are stored in the previously selected pages and prior searches database 117. In other embodiments, as provided below, other passive and active user data associated with the selected Web pages containing information is stored in the user data database 117. In an alternative embodiment, the results page 320 includes an informational privacy button 328 that a user may activate to prevent the server from storing the selected Web pages containing information (or links thereto) and the active and passive user data.

The results page can also include a scoring field 326 for each hyperlink 322. The scoring field 326 permits the user to rank the corresponding hyperlink 322 based on the relevancy of the hyperlink 322 to the important terms. The server 112 links the scoring information to the important terms and stores the scoring information in the user data database 117. The scoring information is “active user data” as it requires the user to actively enter data.

In other embodiments, the server 112 monitors the amount of times users of the search site 110 select Web pages 120 and stores the amount of times that a particular user selected a particular Web page in the user data database 117. In yet other embodiments, the server 112 monitors and stores in the user data database 117 the date and time a particular user last selected a Web page. The number of times a user selects a Web page and the date and time the user selected the web page is “passive user data.” Preferably, the hyperlinks 322 in the results page 320 are ranked according to the active and passive user data. The active and passive user data provides a user with the benefit of the experience of past users of the query, and past system data concerning the query results.

Having thus described a preferred embodiment of a method and system for searching a wide area network, it should be apparent to those skilled in the art that certain advantages of the within method and system have been achieved. It should also be appreciated that various modifications, adaptations, and alternative embodiments thereof may be made within the scope and spirit of the present invention. The invention is further defined by the following claims.

What is claimed is:

1. A method for searching a wide area network, comprising:
selecting a set of information to be searched determined from prior activity of a predetermined user, the set of information comprising information from a database of information previously selected by the predetermined user;
defining a search query for locating desired information; and,
searching the set of information for obtaining at least hyperlinks to a relevant page containing the desired information.

2. The method of claim 1, wherein the selecting step further comprises a user selecting the set of information comprising information previously selected by the user, the predetermined user being the user.

3. The method of claim 1, wherein the selecting step further comprises a user selecting the set of information comprising information previously selected by other users, the predetermined user being one of the other users.

4. The method of claim 3, wherein the selecting step further comprises identifying the other users.

5. The method of claim 4, wherein the identifying step further comprises identifying an important term of the search query and searching a plurality of query strings for the important term to identify the other users, wherein the plurality of query strings includes query strings recorded during previous searches by users of the wide area network.

6. The method of claim 5, wherein the selecting step further comprises searching for the important term in query strings recorded during prior searches by users of a local area network, the wide area network further comprising the local area network.

7. The method of claim 5, further comprising selecting a search site, wherein the selecting a set of information step further comprises searching for the important term query strings recorded during prior searches by users of the search site.

8. The method of claim 1, further comprising collecting user data pertaining to said relevant page, wherein user data includes passive user data and active user data.

9. The method of claim 9, further comprising the step of generating at least one result page containing a plurality of hyperlinks to relevant pages containing the desired information, and the step 8 ranking the plurality of hyperlinks based on the user data pertaining to said relevant page.

11. The method of claim 1, further comprising limiting the set of information to be searched based on a date restriction, wherein the searching step further comprises searching the limited set of information.

12. The method of claim 1, further comprising selectively storing hyperlinks to web pages selected by users of a search site, wherein the hyperlinks are not stored when the privacy option is activated.

13. A computer-implemented system for searching a wide area network from a user computer in communication with the network and having a browser application, comprising:
a Web host in communication with the network, the Web host comprising a Web server having a search interface application executing thereon; and
a memory in communication with the Web server, the memory comprising information previously selected by a predetermined user,
wherein said search interface application performs the functions of:
(a) receiving input from a user using said search interface application for defining a search query for locating desired information and for selecting a set of the previously selected information to be searched, the user input for selecting being determined from prior activities of the predetermined user; and,
(b) searching the selected set of information for obtaining at least hyperlinks to a relevant page containing the desired information.

14. The system of claim 13, wherein the set of information was previously selected by the user.

15. The system of claim 13, wherein the set of information was previously selected by another user.

16. The system of claim 15, wherein the memory further comprises a set of query strings defined by other users of the system, and wherein the search interface further performs the function of identifying the another user by identifying an important term of the search query and searching the set of query strings for the important term.

17. The system of Clam 13, wherein the memory further comprises active user data and passive user data.

18. The system of claim 17, wherein the search interface further performs the function of generating at least one result page containing a plurality of hyperlinks to relevant pages containing the desired information and the function of ranking the plurality of hyperlinks based on the user data pertaining to the said relevant page.

19. The system of claim 13, further comprising a local area network, the local area network comprising a plurality of user computers and a server computer, each user computer comprising a web browser in communication with the server, wherein the server comprises the memory and is in communication with the Web host.

20. The system of claim 13, wherein the search interface further performs the function of selectively storing hyperlinks to web pages selected by users of the system, wherein the hyperlinks are not stored when the privacy option is activated.
